(19) United States
(12) Patent Application Publication
(10) Pub. No.: US 2021/0201401 A1
(43) Pub. Date: Jul. 1, 2021

(54) LENDING AND COLLECTING METHOD AND SYSTEM

(71) Applicant: MIRACLE SHEPPARD, DALLAS, TX (US)

(72) Inventor: MIRACLE SHEPPARD, DALLAS, TX (US)

(21) Appl. No.: 16/732,074

(22) Filed: Dec. 31, 2019

(51) Int. Cl. G06Q 40/02; G06Q 30/02

(52) U.S. Cl. CPC G06Q 40/025; G06Q 30/0234

(57) ABSTRACT

Embodiments of the present invention disclose a method, a computer program product, and a system for incentivizing a cosigner to cosign for a loan and to ensure the borrower repays the loan. Embodiments of the present invention send a first incentive gift to a cosigner in response to determining a set of borrowers have paid the corresponding set of loans in full. Furthermore, sends a second incentive gift to the cosigner in response to determining the number of borrowers associated with the cosigner is greater than a threshold value. Furthermore, transfers funds to a borrower without a cosigner upon determining a number of fully paid loans associated with the borrower and the cosigner is greater than a loan threshold value.

### BACKGROUND OF THE INVENTION

### 1. Field of the Invention

The present application relates to the field of mobile banking, and more particularly to loans requiring a cosigner.

### 2. Description of Related Art

In general, loan agreements involve two parties: a lender and a borrower. As part of a loan agreement, the borrower has an obligation to repay the lender the loan principal as well as any accrued interest. In most situations, loan interest for a loan is determined based on a variety of economic factors relating to the borrower, such as employment status, debt-to-income ratio, and financial reputation such as credit scores. For borrowers who have a healthy financial history, the lender generally will assign a low interest rate since the borrower is expected to be a low risk in defaulting on the loan. Conversely, for borrowers who have a poor financial history, the lender will assign a high interest rate since the lender assumes a greater risk in giving a loan to a borrower who may not pay it back. As a way to mitigate risk, offer a better interest rates, and offer greater principal on the loan, the lender can require a cosigner to vouch for the borrower by becoming jointly responsible for paying off the loan. Should the borrower default on paying off the loan, the cosigner becomes responsible for paying any remainder of the outstanding debt. However, as this method currently stands, there is no incentive for the cosigner to take on the risk of being jointly responsible for a borrower who has a poor credit history, which can become a problem for a borrower as the borrower may have difficulty finding a cosigner willing to take on the risk.

It is then desired to incentivize a cosigner to cosign for a borrower as well as opening a means for the borrower to improve their financial history to standing that no longer requires the cosigner to cosign for the borrower.

### BRIEF SUMMARY OF THE INVENTION

Embodiments of the present invention disclose a method, a computer program product, and a system for incentivizing a cosigner to cosign for a loan and to ensure the borrower repays the loan while additionally improving a financial history of the borrower to a state that permits the borrower to take future loans without requiring the cosigner to sign for the future loans. In one embodiment of the present invention, a method is provided comprising: determining a set of borrowers have paid a corresponding set of loans in full, and in response to determining the set of borrowers have paid the corresponding set of loans in full, sending a first incentive gift to a cosigner associated with the set of loans. In further embodiments, the method provided comprises: determining a number of borrowers associated with the cosigner is greater than a threshold value, and in response to determining the cosigner is associated with the number of borrowers, wherein the number of borrowers exceeds the threshold value, sending a second incentive gift to the cosigner. In even further embodiments, the method provided comprises: receiving a request from a borrower among the set of borrowers for a loan; determining a number of fully paid loans associated with the borrower and the cosigner is greater than a loan threshold value; and transferring funds corresponding to the request to a financial account of the borrower without requiring the cosigner to sign for the loan.

The act of being a cosigner in the present system can be considered a job in and of itself wherein the individual may work from home or any other remote location. Payment is received for loans they are acting as cosigners for and may be with borrowers they already know or are willing to work with (unknown to them originally). A cosigner may use their individual network and choose to expand their network of people to control the amount of money made through the system.

Ultimately the invention may take many embodiments. In these ways, the present invention overcomes the disadvantages inherent in the prior art.

The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions in so far as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a functional block diagram illustrating a lending environment, in accordance with an embodiment of the present application;

FIG. 2 is a flowchart depicting operational steps of a lending program that incentivizes a cosigner to cosign with a borrower for a loan, incentivizes the cosigner to ensure the borrower pays off the loan, and transitions the borrower to a financial standing that no longer requires the cosigner for further loans, in accordance with an embodiment of the present invention; and

FIG. 3 depicts a block diagram of components of the computing system of FIG. 1, in accordance with an embodiment of the present invention.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

Embodiments of the present invention overcomes one or more of the above-discussed problems commonly associated with borrowers obtaining a loan from a lender and incentivizing a cosigner to cosign for the loan. The embodiments of the present invention, and combination thereof, provide solutions for incentivizing a cosigner to cosign for a loan and to ensure the borrower repays the loan while additionally improving a financial history of the borrower to a state that permits the borrower to take future loans without requiring the cosigner. As described in greater detail later in the specification, embodiments of the present invention provide incentive gifts to the cosigner upon payment completion a set of loans corresponding to a set of borrowers, provides incentive gifts to the cosigner for cosigning for a predetermined number of borrowers for a corresponding set of loans, and permits a borrower to receive additional loans without the cosigner upon completion of a predetermined number of fully paid loans associated with the borrower and the cosigner.

Implementation of embodiments of the invention may take a variety of forms, and exemplary implementation details are discussed subsequently with reference to the figures. Several embodiments may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

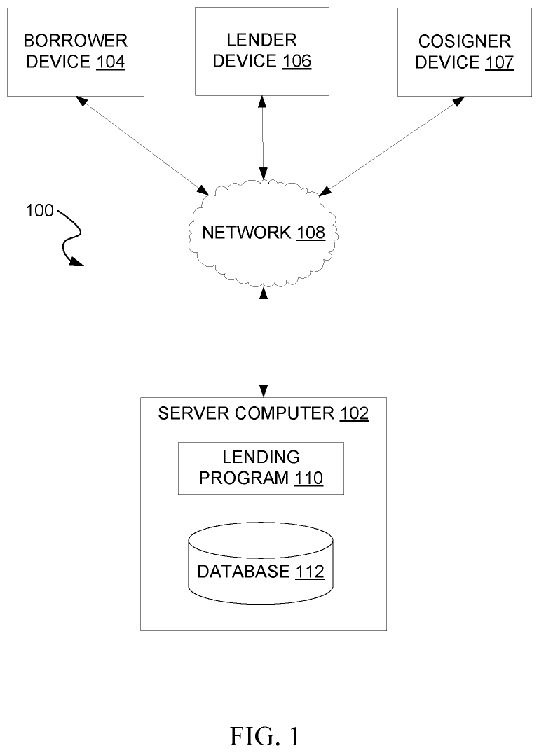

FIG. 1 is a functional block diagram illustrating a lending environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

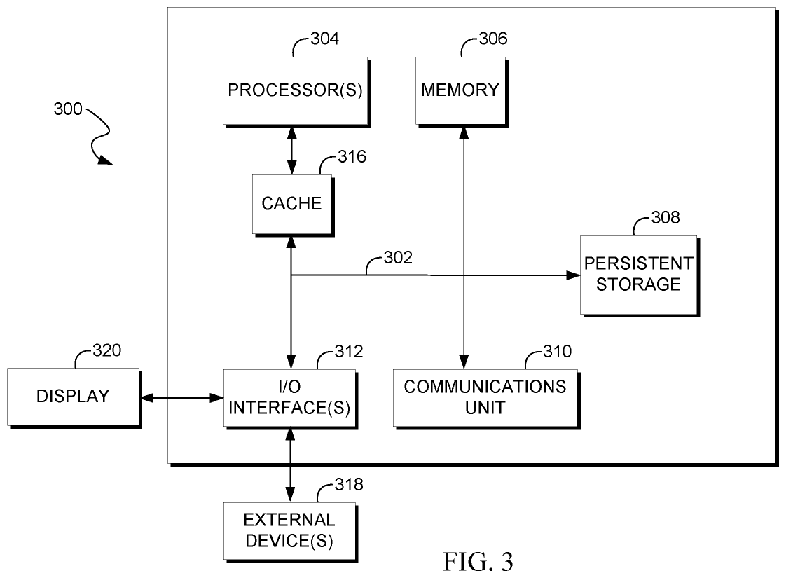

Lending environment 100 includes server computer 102, borrower device 104, lender device 106, and cosigner device 107, all interconnected over network 108. Server computer 102, borrower device 104, lender device 106, and cosigner device 107 can be a standalone computing device, a management server, a webserver, a mobile computing device, or any other electronic device or computing system capable of receiving, sending, and processing data. In other embodiments, server computer 102, borrower device 104, lender device 106, and cosigner device 107 can represent a server computing system utilizing multiple computers as a server system, such as in a cloud computing environment. In another embodiment, server computer 102, borrower device 104, lender device 106, and cosigner device 107 can be a laptop computer, a tablet computer, a netbook computer, a personal computer (PC), a desktop computer, a personal digital assistant (PDA), a smart phone, or any programmable electronic device capable of communicating with various components and other computing devices (not shown) within lending environment 100. In another embodiment, server computer 102, borrower device 104, lender device 106, and cosigner device 107 each represent a computing system utilizing clustered computers and components (e.g., database server computers, application server computers, etc.) that act as a single pool of seamless resources when accessed within lending environment 100. Server computer 102, borrower device 104, lender device 106, and cosigner device 107 may include internal and external hardware components capable of executing machine-readable program instructions, as depicted and described in further detail with respect to FIG. 3. Sever computer 102 and lender device 106 may be a single device.

As used herein, borrower device 104 is associated with borrower for a loan, lender device 106 is associated with a lender for a loan, and cosigner device 107 is associated with a cosigner for a loan.

Server computer 102 includes lending program 110 and database 112. In general, lending program 110 monitors a set of loans corresponding to a set of borrowers. Furthermore, lending program 110 is capable of receiving payment for loan from a borrower, transferring loan funds to a borrower, and sending gifts to a cosigner such as a predetermined amount of funds to a cosigner. In one embodiment, lending program 110 determines a set of borrowers have paid a corresponding set of loans in full, and in response the determination, sends a first incentive gift to a cosigner associated with the set of loans. In a further embodiment, lending program 110 determines a number of borrowers associated with the cosigner is greater than a threshold value, and in response to the determination, sends a second incentive git to the cosigner. In an even further embodiment, lending program 110 receives a request from a borrower among the set of borrowers for a long, determines a number of fully paid loans associated with the borrower and the cosigner is greater than a loan threshold value, and in response to the determination, transfers funds corresponding to the request to a financial account of the borrower without requiring the cosigner to sign for the loan.

Database 112 is a repository for data accessible by lending program 110. Database 112 can be implemented with any type of storage device capable of storing data and configuration files that can be accessed and utilized by server computer 102, such as a database server, a hard disk drive, or a flash memory. Database 112 stores a set of accounts, the set of accounts including accounts associated with a set of borrowers, a lender, and a cosigner associated with the set of borrowers. The set of accounts include, but is not limited to, financial accounts, loan accounts, transaction records, and information identifying a cosigner associated with the set of borrowers. As used herein, “funds” and “an amount of currency” are used interchangeably.

Network 108 can be, for example, a telecommunications network, a local area network (LAN), a wide area network (WAN), such as the Internet, or a combination of the three, and can include wired, wireless, or fiber optic connections. Network 108 can include one or more wired and/or wireless networks that are capable of receiving and transmitting data, voice, and/or video signals, including multimedia signals that include voice, data, and video information. In general, network 108 can be any combination of connections and protocols that will support communications among server computer 102, borrower device 104, lender device 106, cosigner device 107, and other computing devices (not shown) within lending environment 100.

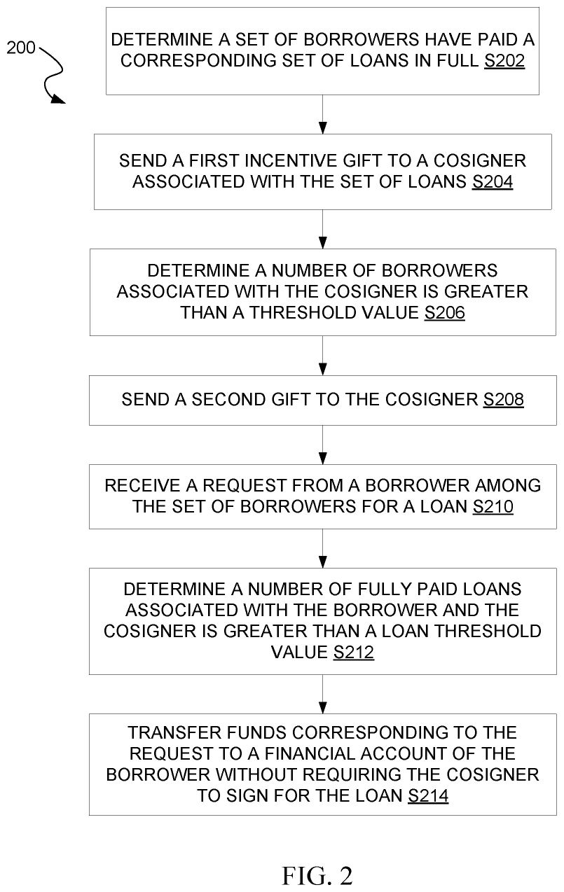

FIG. 2 is a flowchart 200 depicting operational steps of a lending program that incentivizes a cosigner to cosign with a borrower for a loan, incentivizes the cosigner to ensure the borrower pays off the loan, and transitions the borrower to a financial standing that no longer requires the cosigner for further loans, in accordance with an embodiment of the present invention.

In step S202, lending program 110 determines a set of borrowers have paid a corresponding set of loans in full. In this embodiment, lending program 110 continuously monitors on database 112 a set of loans corresponding to a set of borrowers associated with a cosigner and determines whether the set of borrowers have paid the corresponding set of loans in full. For example, a cosigner cosigned for a single loan corresponding to a borrower. When the borrower makes a final payment to pay off the single loan, lending program 110 determines the borrower has paid off the single loan in full based on the loan account record stored on database 112, and in response to the determination, initiates step S204. In some embodiments, lending program 110 requires a set number of borrowers to have paid off a corresponding set of loans before determining the set of borrowers have paid off the corresponding set of loans. For example, lending program 110 requires that five borrowers associated with the cosigner be fully paid off to trigger lending program 110 to initiate step S204. In a further embodiment, lending program 110 triggers S204 for each iteration of the set number of borrowers that accomplish paying of their loans. For example, for a first set of five borrowers associated with a cosigner that finish paying off their loans, lending program 110 triggers step S204. Lending program 110 triggers step S204 again once a second set of five borrowers associated with the cosigner finish paying off their loans.

In step S204, in response to determining the set of borrowers have paid the corresponding set of loans in full, lending program 110 sends a first incentive gift to a cosigner associated with the set of loans. In one embodiment, lending program 110 sends the first incentive gift to the cosigner by transferring a predetermined amount of funds to a financial account of the cosigner as a reward for ensuring the set of borrowers paid off their loans. In one embodiment, the predetermined amount of funds is a constant amount of funds. For example, the gift the cosigner receives are iterations of five dollars. In another embodiment, the predetermined amount of founds is a percentage of a loan paid off by a borrower. For example, for a loan consisting of one hundred dollars with a gift percent for a corresponding cosigner for the loan being one percent, loan program 110 transfers one dollar to an account of the cosigner upon determining a borrower associated with the loan has repaid the loan in full. In an alternate embodiment, lending program 110 sends the first incentive gift to the cosigner by displaying a notification on lender device 106 informing a lender to send a physical gift to the cosigner, wherein the physical gift can be a calendar, a thank you card, etc.

In step S206, lending program 110 determines a number of borrowers associated with the cosigner is greater than a threshold value. In one embodiment, lending program 110 continuously monitors database 112 for a number of borrowers having loan accounts associated with a cosigner, wherein each borrower among the number of borrower are first time borrowers with the cosigner. When lending program 110 determines the number of borrowers is greater than a threshold value, lending program 110 initiates step 208, wherein the threshold value is a predetermined value. For example, lending program 110 has a threshold value of two. In this example, borrower A and borrower B are first time borrowers each having a cosigner for a loan from a lender. Borrower C associated with the cosigner borrows a second loan after having paid off a first loan. Lending program 110 determines that the cosigner has three borrowers associated with the cosigner, but since borrower C is not a first time borrower, then the number of borrowers associated with the cosigner is not greater than the threshold value of two. However, at a later time, lending program 110 determines that borrower D is associated with the cosigner, and thereby determines that the number of borrowers associated with the cosigner is greater than two since borrower A, B, and D are each first time borrowers.

In step S208, in response to determining the number of borrowers associated with the cosigner is greater than the threshold value, lending program 110 sends a second gift to the cosigner. In this embodiment, the second gift to the cosigner is of similar form and function as the first gift of step S204.

In step S210, lending program 110 receives a request from a borrower among the set of borrowers for a loan. In one embodiment, lending program 110 receives the request from borrower device 104. In another embodiment, lending program 110 receives the request from lender device 106 for the borrower. In this embodiment, the request is a loan application requesting to borrow an amount of funds as a loan from a lender.

In step S212, in response to receiving the request from the borrower for the loan, lending program 10 determines a number of fully paid loans associated with the borrower and the cosigner is greater than a loan threshold value. In this embodiment, determines the number of fully paid loans associated with the borrower and the cosigner is greater than the loan threshold value by checking database 112 for the number fully paid off loans associated with the borrower and comparing the number to the loan threshold value. In this embodiment, the loan threshold value is a predetermined value. For example, lending program 110 has a loan threshold value of two. In this example, borrower E in the past needed a cosigner to cosign for three previous loans from a lender and fully paid off the three previous loans in full. At a later time, borrower E applies for a fourth loan. Lending program 110 receives a request for the fourth loan from borrower device 104 and determines borrower E has paid off the three previous loans based accounts associated with borrower E stored on database 112. Lending program 110 determines that the three previous loans that were fully paid off is greater than the loan threshold value of two, and subsequently proceeds to step S214. Each loan is customized to each person and the number of loans needing a cosigner may vary between loan conditions and borrowers.

In step S214, in response to determining the number of fully paid loans associated with the borrower and the cosigner is greater than the loan threshold value, lending program 110 transfers funds corresponding to the request to a financial account of the borrower without requiring the cosigner to sign for the loan. In this embodiment, since the borrower has demonstrated a reputation of paying off loans to the lender, lending program 110 waives a cosigner requirement for the borrower. For example, in continuing the example of step S212, upon determining that borrower E has three previous loans that were fully paid off and that the three paid off loans is greater than the loan threshold value of two, lending program 110 transfers funds to an account of borrower E without needing a cosigner.

In a further embodiment, upon determining the borrower has paid the requested loan off in full, lending program 110 rewards the cosigner for cosigning prior loans of the borrower as a way of thanking the cosigner for improving a financial reputation of the borrower. In this embodiment, lending program 110 rewards the cosigner by sending a third gift to the cosigner, wherein the third gift is of similar form and function as the first gift. For example. In continuing the example of step S214, borrower E fully pays off the requested fourth loan that did not need the cosigner to sign for the loan. Upon determining borrower E has fully paid off the request fourth loan, lending program 110 sends a gift to the cosigner associated with the previous three loans of borrower E.

FIG. 3 depicts a block diagram of components of computing systems within lending environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 300 includes communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Lending program 110 may be stored in persistent storage 308 and in memory 306 for execution by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Lending program 110 may be downloaded to persistent storage 308 through communications unit 310.

I/O interface(s) 312 allows for input and output of data with other devices that may be connected to server computer 102, borrower device 104, lender device 106, and/or cosigner device 107. For example, I/O interface 312 may provide a connection to external devices 316 such as a keyboard, keypad, a touch screen, a microphone, and/or some other suitable input device. External devices 316 can also include portable computer readable storage media such as, for example, thumb drives, portable optical or magnetic disks, and memory cards. Software and data used to practice embodiments of the present invention, e.g., lending program 110, can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A computer-implemented method comprising:
determining a set of borrowers have paid a corresponding set of loans in full; and
in response to determining the set of borrowers have paid the corresponding set of loans in full, sending a first incentive gift to a cosigner associated with the set of loans.

2. The computer-implemented method of claim 1, wherein sending the incentive gift comprises transferring a predetermined amount of funds to a financial account of the cosigner.

3. The computer-implemented method of claim 1, further comprising:
determining a number of borrowers associated with the cosigner is greater than a threshold value; and
in response to determining the cosigner is associated with the number of borrowers, wherein the number of borrowers exceeds the threshold value, sending a second incentive gift to the cosigner.

4. The computer-implemented method of claim 3, wherein each borrower among the number of borrowers are first time borrowers with the cosigner and a lender.

5. The computer-implemented method of claim 3, wherein sending the second incentive gift comprises transferring a predetermined amount of funds to a financial account of the cosigner.

6. The computer-implemented method of claim 1, further comprising:
receiving a request from a borrower among the set of borrowers for a loan;
determining a number of fully paid loans associated with the borrower and the cosigner is greater than a loan threshold value; and
transferring funds corresponding to the request to a financial account of the borrower without requiring the cosigner to sign for the loan.

7. The computer-implemented method of claim 6, further comprising:
in response to determining the borrower has paid the requested loan in full, sending a second incentive gift to the cosigner.

8. A computer program product comprising:
one or more computer readable storage media and program instructions stored on the one or more computer readable storage media, the program instructions comprising:
program instructions to determine a set of borrowers have paid a corresponding set of loans in full; and
in response to determining the set of borrowers have paid the corresponding set of loans in full, program instructions to send a first incentive gift to a cosigner associated with the set of loans.

9. The computer program product of claim 8, wherein the program instructions to send the incentive gift comprise program instructions to transfer a predetermined amount of funds to a financial account of the cosigner.

10. The computer program product of claim 8, further comprising:
program instructions to determine a number of borrowers associated with the cosigner is greater than a threshold value; and
in response to determining the cosigner is associated with the number of borrowers, wherein the number of borrowers exceeds the threshold value, program instructions to send a second incentive gift to the cosigner.

11. The computer program product of claim 10, wherein each borrower among the number of borrowers are first time borrowers with the cosigner and a lender.

12. The computer program product of claim 10, wherein the program instructions to send the second incentive gift comprise program instructions to transfer a predetermined amount of funds to a financial account of the cosigner.

13. The computer program product of claim 8, further comprising:
program instructions to receive a request from a borrower among the set of borrowers for a loan;
program instructions to determine a number of fully paid loans associated with the borrower and the cosigner is greater than a loan threshold value; and
program instructions to transfer funds corresponding to the request to a financial account of the borrower without requiring the cosigner to sign for the loan.

14. The computer program product of claim 13, further comprising:
in response to determining the borrower has paid the requested loan in full, program instructions to send a second incentive gift to the cosigner.

15. A computer system comprising:
one or more computer processors;
one or more computer readable storage media; and
one or more computer readable storage media and program instructions stored on the one or more computer readable storage media, the program instructions comprising:
program instructions to determine a set of borrowers have paid a corresponding set of loans in full; and
in response to determining the set of borrowers have paid the corresponding set of loans in full, program instructions to send a first incentive gift to a cosigner associated with the set of loans.

16. The computer system of claim 15, wherein the program instructions to send the incentive gift comprise program instructions to transfer a predetermined amount of funds to a financial account of the cosigner.

17. The computer system of claim 15, further comprising:
program instructions to determine a number of borrowers associated with the cosigner is greater than a threshold value; and
in response to determining the cosigner is associated with the number of borrowers, wherein the number of borrowers exceeds the threshold value, program instructions to send a second incentive gift to the cosigner.

18. The computer system of claim 17, wherein each borrower among the number of borrowers are first time borrowers with the cosigner and a lender.

19. The computer system of claim 17, wherein the program instructions to send the second incentive gift comprise program instructions to transfer a predetermined amount of funds to a financial account of the cosigner.

20. The computer system of claim 15, further comprising:
program instructions to receive a request from a borrower among the set of borrowers for a loan;
program instructions to determine a number of fully paid loans associated with the borrower and the cosigner is greater than a loan threshold value; and
program instructions to transfer funds corresponding to the request to a financial account of the borrower without requiring the cosigner to sign for the loan.
